(19) United States
(12) Patent Application Publication
(10) Pub. No.: US 2004/0172328 A1
(43) Pub. Date: Sep. 2, 2004

(54) Information presentation system, advertisement presentation system, information presentation program, and information presentation method

(76) Inventor: Yoshiki Fukui, Suwa-shi (JP)

Correspondence Address: HARNESS, DICKEY & PIERCE, P.L.C., P.O. BOX 828, BLOOMFIELD HILLS, MI, 48303, US

(21) Appl. No.: 10/736,884

(22) Filed: Dec. 16, 2003

(30) Foreign Application Priority Data
Dec. 16, 2002 (JP) 2002-363311

(51) Int. Cl. G06F 17/60

(52) U.S. Cl. 705/14

(57) ABSTRACT

An information presentation system is provided having a display device that is installed as part of a shop window, a plurality of image photographing devices that can capture landscape images around the display device, including a target person, at different angles, and an advertising-information registration database that stores advertising information. An mirror image of a peripheral landscape around the display device is generated based on the images captured with the image photographing devices and an advertisement image is superimposed on the generated mirror image to display the superimposed advertisement image in the display device as part of the peripheral landscape based on the advertising information stored in the advertising-information registration database.

### BACKGROUND OF THE INVENTION

1. Technical Field of the Invention

The present invention relates to a system, program, and method for presenting information. More specifically, the present invention relates to an information presentation system, an advertisement presentation system, an information presentation program, and an information presentation method that are less troublesome for target people, have a broad application, and preferably improve advertising effect in the application to advertisement display.

2. Description of the Related Art

Heretofore, a technique in which virtual images are superimposed on actual visual images for displaying information by using image processing technology, such as virtual reality technology, has been widely known. Such techniques include, for example, a head-mounted display disclosed in Japanese Unexamined Patent Application Publication No. 2000-152125 (hereinafter referred to as first related art) and a digital mirror disclosed in Japanese Unexamined Patent Application Publication No. 2002-290964 (hereinafter referred to as second related art).

In the first related art, an icon is displayed at a position on which a target person turns his/her line of sight in an image outputting unit with an operating unit. The position is detected with a sight-line detecting unit. The icon is superimposed on a real view that can be seen from a window, viewed from the target person. The target person turns his/her line of sight upon a desired position in the view to determine the desired position through an instruction with the operating unit. For example, when the target person observes a sentence that is actually in the face of the target person and specifies a certain area in the sentence, a sentence or a word in the specified area is read from image information input with a CCD (charge coupled device) camera in an image processor and the read sentence or word is translated into an arbitrary language to be displayed in the image outputting unit.

In this manner, an image such as an icon that is a virtual image can be superimposed on a real view, and the icon can be shifted in accordance with the movement of the sight line of the target person in order to specify a desired position in the view.

In the second related art, a monitor screen is installed at a position where the mirror of a vanity unit is installed, and a first visual sensor and a second visual sensor, each having a plurality of pairs of cameras, are installed on either side of the monitor screen. Three-dimensional image data is captured from the first and second visual sensors to be supplied to an image processor. The image processor forms an image viewed from a certain direction with respect to the target person based on the supplied image data, and synthesizes information, such as weather or news, that is appropriately downloaded over the Internet, for displaying the synthesized information in the monitor screen. The image of a user can be converted into an image in an arbitrary direction, an enlarged image, or the like through an instruction for display. A variety of information can be further displayed in the monitor screen.

In this manner, an image in an arbitrary direction, such as an image viewed from the front of the user, can be output to the monitor screen for display and a variety of information can be further displayed in the monitor screen.

However, in the first related art, there is a problem in that the need for the target person to wear the head-mounted display is troublesome for the target person and restricts the application.

In the second related art, since a variety of information, such as weather or news, is simply superimposed on the mirror image of the target person to be displayed in the monitor screen, the displayed information has little relevance to the mirror image of the target person in relation to display. For example, when the second related art is applied to advertisement display, advertisement looks as if it were displayed independently of the mirror image of the target person although the advertisement is superimposed on the mirror image of the target person and, thus, it is difficult to surprise the target person. Hence, there is a problem in that the target person is less impressed with the advertisement and sufficient advertisement effect is not provided.

Accordingly, in order to solve these problems of the related art, an object of the present invention is to provide an information presentation system, an advertisement presentation system, an information presentation program, and an information presentation method that are less troublesome for target people, have a broad application, and preferably improve the advertising effect in the application to the advertisement display.

### SUMMARY

In order to achieve the above object, an information presentation system according to a first embodiment includes a reflected-image displaying medium for displaying a reflected image of a peripheral landscape that will be reflected in a mirror when a target person to whom information is presented looks at the mirror, presentation-information storing means for storing presentation information to be presented, and information displaying means for displaying the information in the reflected-image displaying medium based on the presentation information stored in the presentation-information storing means.

The information displaying means superimposes the information on the reflected image displayed in the reflected-image displaying medium to display the superimposed information as part of the peripheral landscape, based on the presentation information stored in the presentation-information storing means.

With this structure, the reflected image of the peripheral landscape that will be reflected in the mirror when the target person looks at the mirror is displayed in the reflected-image displaying medium. The information displaying means displays the information that is superimposed on the reflected image displayed in the reflected-image displaying medium, as part of the peripheral landscape, based on the presentation information stored in the presentation-information storing means.

Since the information is presented with the reflected-image displaying medium, it is not necessary for the target person to wear an accessory such as a head-mounted display, thus being less troublesome for the target person and having a relatively broad application, compared with conventional cases. Furthermore, in the application of the information presentation system to advertisement display, since the information is displayed as part of the peripheral landscape, the information is surprisingly displayed to the target person as part of peripheral landscape in the mirror image of the reflected-image displaying medium although the information does not actually exist in a visual image. Hence, the target person is more impressed with the advertisement and advertising effect can be improved compared with conventional cases.

The reflected-image displaying medium may be any medium that can display a reflected image. For example, the reflected-image displaying medium may be a mirror itself or may be displaying means, such as a display, that can display an image. The same applies to an advertisement presentation system according to a second embodiment, an information presentation program according to an eighth embodiment, and an information presentation method according to a ninth embodiment.

The presentation-information storing means stores presentation information with any means at any time. It may store the presentation information in advance or may store the presentation information through an external input while the information presentation system is activated without the presentation information being stored in advance. The same applies to the information presentation program according to the eighth embodiment.

The information presentation system may be realized as a single apparatus, terminal, or other device or may be realized as a network system in which a plurality of apparatuses, terminals, or other devices are connected to each other for communication. In the latter case, each component may be included in any of the devices or the like if it is connected for communication. The same applies to the advertisement presentation system according to the second embodiment.

In order to achieve the above object, an advertisement presentation system according to a second embodiment includes a reflected-image displaying medium for displaying a reflected image of a peripheral landscape that will be reflected in a mirror when a target person to whom advertisement is presented looks at the mirror, advertising-information storing means for storing advertising information to be presented, and advertisement displaying means for displaying the advertisement in the reflected-image displaying medium based on the advertising information stored in the advertising-information storing means.

The advertisement displaying means superimposes an advertisement image on the reflected image displayed in the reflected-image displaying medium to display the superimposed advertisement image as part of the peripheral landscape, based on the advertising information stored in the advertising-information storing means.

With this structure, the reflected image of the peripheral landscape that will be reflected in the mirror when the target person looks at the mirror is displayed in the reflected-image displaying medium. The advertisement displaying means displays the advertisement image that is superimposed on the reflected image displayed in the reflected-image displaying medium, as part of the peripheral landscape, based on the advertising information stored in the advertising-information storing means.

Since the advertisement is presented with the reflected-image displaying medium, it is not necessary for the target person to wear an accessory such as a head-mounted display, thus the advertisement presentation system being less troublesome for the target person and having a relatively broad application is advantageously achieved, compared with conventional cases. Furthermore, since the advertisement image is displayed as part of the peripheral landscape, the advertisement is surprisingly displayed to the target person as part of peripheral landscape in the mirror image of the reflected-image displaying medium although the advertisement does not actually exist in a visual image. Hence, the target person is more impressed with the advertisement and advertising effect can be improved compared with conventional cases.

The advertising-information storing means stores advertising information with any means at any time. It may store the advertising information in advance or may store the advertising information through an external input while the advertisement presentation system is activated without the advertising information being stored in advance.

According to a third embodiment, in the advertisement presentation system according to the second embodiment, the reflected-image displaying medium is displaying means in which an image can be displayed, and the advertisement presentation system further includes a plurality of landscape-image capturing means for capturing landscape images around the reflected-image displaying medium and mirror-image generating means for generating a mirror image of the peripheral landscape around the reflected-image displaying medium based on the landscape images captured with the landscape-image capturing means.

The advertisement displaying means superimposes the advertisement image on the mirror image that is generated in the mirror-image generating means to display the superimposed advertisement image in the displaying means as part of the peripheral landscape, based on the advertising information stored in the advertising-information storing means.

With this structure, the plurality of landscape-image capturing means capture the landscape images around the reflected-image displaying medium, and the mirror-image generating means generates the mirror image of the peripheral landscape around the reflected-image displaying medium based on the captured landscape images. The advertisement displaying means superimposes the advertisement image on the generated mirror image to display the superimposed advertisement image in the displaying means as part of the peripheral landscape, based on the advertising information stored in the advertising-information storing means.

Since the mirror image of the peripheral landscape around the reflected-image displaying medium is generated based on the images captured with the plurality of the landscape-image capturing means, the mirror image that is close to an actual reflected image in the mirror can be generated. It is enough to superimpose the advertisement image on the mirror image generated in image processing, so that relatively easy and accurate superimposition of the advertisement image can be achieved.

According to a fourth embodiment, in the advertisement presentation system according to the third embodiment, the advertisement presentation system further includes positional-relationship detecting means for detecting positional relationship between the reflected-image displaying medium and the target person.

When the reflected-image displaying medium is a plane mirror that faces a predetermined direction, the mirror-image generating means generates the mirror image of the peripheral landscape that will be reflected in the plane mirror viewed from the target person based on the result detected with the positional-relationship detecting means.

With this structure, the positional-relationship detecting means detects the positional relationship between the reflected-image displaying medium and the target person. When the reflected-image displaying medium is the plane mirror that faces a predetermined direction, the mirror-image generating means generates the mirror image of the peripheral landscape that will be reflected in the plane mirror viewed from the target person based on the detected positional relationship.

Since the mirror image of the peripheral landscape that will be reflected in the plane mirror viewed from the target person is generated, the mirror image that is closer to an actual reflected image in the mirror can be generated.

The positional relationship between the reflected-image displaying medium and the target person includes, for example, the relative position of the target person with respect to the reflected-image displaying medium, the relative position of the reflected-image displaying medium with respect to the target person, and the absolute positions of the reflected-image displaying medium and the target person.

Although the mirror-image generating means generates the mirror image that will be reflected in the plane mirror viewed from the target person based on the result detected with the positional-relationship detecting means when the reflected-image displaying medium is the plane mirror that faces a predetermined direction, the present invention is not limited to this structure. Other structures in which a mirror image that is close to an actual reflected image in the mirror is generated include the following structure. Namely, when the reflected-image displaying medium is a plane mirror that faces the front of the target person, the mirror-image generating means generates the mirror image that will be reflected in the plane mirror viewed from the target person based on the result detected with the positional-relationship detecting means. With this structure, since the mirror image of the target person is always displayed in the displaying means even when the target person slightly shifts, the advertisement display focused on the target person can be achieved. Hence, the target person is more impressed with the advertisement and advertising effect can be further improved.

According to a fifth embodiment, in the advertisement presentation system according to the fourth embodiment, the advertisement presentation system further includes target-person-image capturing means for capturing an image of the target person.

The positional-relationship detecting means detects the positional relationship between the reflected-image displaying medium and the target person based on the image captured with the target-person-image capturing means.

With this structure, the target-person-image capturing means captures the image of the target person, and the positional-relationship detecting means detects the positional relationship between the reflected-image displaying medium and the target person based on the captured image.

Since the positional relationship between the reflected-image displaying medium and the target person is detected in the image processing, the positional relationship between the reflected-image displaying medium and the target person can be relatively accurately detected.

According to a sixth embodiment, in the advertisement presentation system according to the fourth embodiment, the advertisement presentation system further includes positional-information acquiring means for acquiring positional information of a communication terminal that the target person carries via communication with the communication terminal.

The positional-relationship acquiring means detects the positional relationship between the reflected-image displaying medium and the target person based on the positional information acquired with the positional-information acquiring means.

With this structure, the positional-information acquiring means acquires the positional information of the communication terminal that the target person carries via communication with the communication terminal, and the positional-relationship detecting means detects the positional relationship between the reflected-image displaying medium and the target person based on the acquired positional information.

Since the positional relationship between the reflected-image displaying medium and the target person is detected based on the positional information of the communication terminal that the target person carries, the positional relationship between the reflected-image displaying medium and the target person can be relatively accurately detected. Furthermore, the positional relationship can be relatively easily detected, compared with cases in which the positional relationship is detected in the image processing.

According to a seventh embodiment, in the advertisement presentation system according to any of the third to sixth embodiments, the advertisement presentation system further includes face-image capturing means for capturing a face image of a person around the reflected-image displaying medium and sight-line detecting means for detecting that the person turns his/her line of sight onto the reflected-image displaying medium based on the face image captured with face-image capturing means.

The person who is detected turning his/her line of sight onto the reflected-image displaying medium with the sight-line detecting means is the target person. When the reflected-image displaying medium is the plane mirror that faces a predetermined direction, the mirror-image generating means generates the mirror image of the peripheral landscape that will be reflected in the plane mirror viewed from the target person.

With this structure, the face-image capturing means captures the face image of the person around the reflected-image displaying medium, and the sight-line detecting means detects that the person turns his/her line of sight onto the reflected-image displaying medium based on the captured face image. The person who is detected turning his/her line of sight onto the reflected-image displaying medium with the sight-line detecting means is the target person. When the reflected-image displaying medium is the plane mirror that faces a predetermined direction, the mirror-image generating means generates the mirror image of the peripheral landscape that will be reflected in the plane mirror viewed from the target person.

When a plurality of persons exist around the reflected-image displaying medium, a person who turns his/her line of sight upon the reflected-image displaying medium is the target person, and the mirror image of the peripheral landscape and the advertisement image that will be reflected in the plane mirror viewed from the target person are presented, thus achieving the advertisement presentation targeted at the person who turns his/her line of sight upon the reflected-image displaying medium. Hence, the target person is more impressed with the advertisement and advertising effect can be further improved.

In order to achieve the above object, an information presentation program according to an eighth embodiment causes a computer, which is capable of utilizing a reflected-image displaying medium for displaying a reflected image of a peripheral landscape that will be reflected in a mirror when a target person to whom information is presented looks at the mirror and presentation-information storing means for storing presentation information to be presented, to perform a process realized as information displaying means for displaying the information in the reflected-image displaying medium based on the presentation information stored in the presentation-information storing means.

The information displaying means superimposes the information on the reflected image displayed in the reflected-image displaying medium to display the superimposed information as part of the peripheral landscape, based on the presentation information stored in the presentation-information storing means.

With this structure, the information presentation program is read by the computer. Execution of the process by the computer in accordance with the read program provides operation and effect equivalent to those in the information presentation system according to the first embodiment.

In order to achieve the above object, an information presentation method according to a ninth embodiment includes a reflected-image displaying step for displaying a reflected image of a peripheral landscape that will be reflected in a mirror when a target person to whom information is presented looks at the mirror in reflected-image displaying medium and an information displaying step for displaying the information in the reflected-image displaying medium based on presentation information to be presented. The information is superimposed on the reflected image displayed in the reflected-image displaying medium to display the superimposed information as part of the peripheral landscape based on the presentation information in the information displaying step.

With this method, an effect equivalent to that in the information presentation system according to the first embodiment is achieved.

### BRIEF DESCRIPTION OF THE DRAWINGS

FIG. 1 is a block diagram showing the structure of an advertisement display apparatus 100.

FIG. 2 is a diagram showing an installation structure of a display device 42.

FIG. 3 is a diagram showing an installation structure of image photographing devices 44.

FIG. 4 is a flowchart showing advertisement displaying processing.

FIG. 5 illustrates a case in which a mirror image is generated.

FIG. 6 illustrates a case in which an advertisement image is generated.

### DETAILED DESCRIPTION

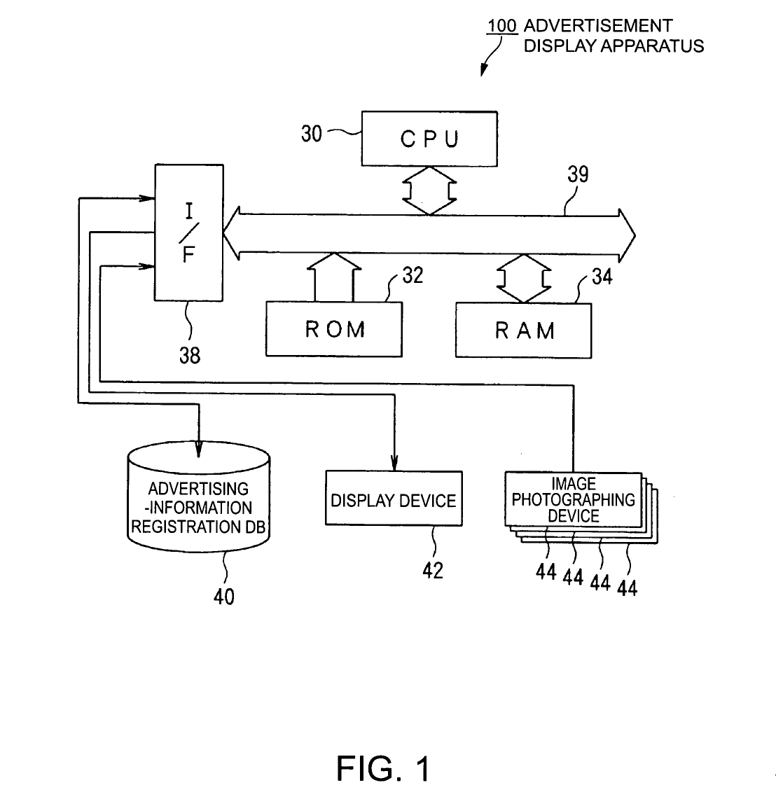

Embodiments of the present invention will be described below with reference to the attached drawings. FIGS. 1 to 6 are diagrams illustrating an information presentation system, an advertisement presentation system, an information presentation program, and an information presentation method according to the embodiments of the present invention.

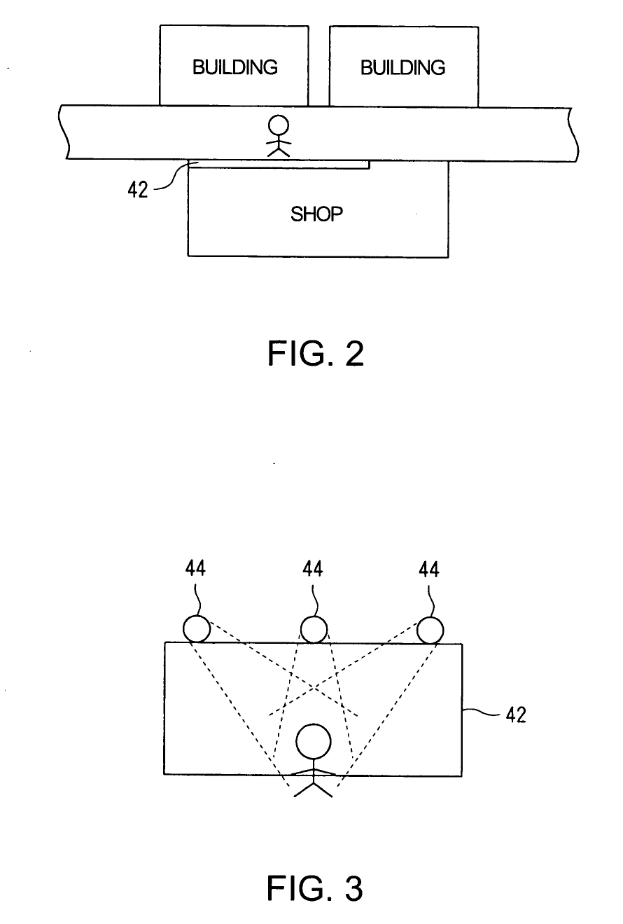

In the embodiments described below, the information presentation system, the advertisement presentation system, the information presentation program, and the information presentation method according to the present invention are applied to a case in which advertisement is presented to a passer-by (hereinafter referred to as a target person) with a display device 42 that is provided as part of a shop window, as shown in FIG. 2.

The structure of an advertisement display apparatus 100 according to the present invention will now be described with reference to FIG. 1.

FIG. 1 is a block diagram showing the structure of the advertisement display apparatus 100.

The advertisement display apparatus 100 has a CPU 30 for executing arithmetic operation and controlling the entire apparatus based on a control program, a ROM 32 that stores the control program of the CPU 30 and so on in a predetermined area in advance, a RAM 34 for storing data read from the ROM 32 and so on and the results of operations necessary for the operation process of the CPU 30, and an I/F 38 that provides an interface for supplying and receiving data to and from external devices, as shown in FIG. 1. These components are connected to each other through a bus 39 that is a signal line for transmitting the data. The data can be transmitted and received between these components through the bus 39.

An advertising-information registration database (database is hereinafter simply referred to as DB) 40 for storing advertising information, the display device 42 for displaying data on a screen based on image signals, and a plurality of image photographing devices 44 for capturing landscape images around the display device 42 are connected to the I/F 38 as the external devices.

FIG. 2 is a diagram showing an installation structure of the display device 42.

The display device 42 faces a road and is installed as part of the shop window such that the target person who passes by on the road in front of the shop can view the display device 42, as shown in FIG. 2.

FIG. 3 is a diagram showing an installation structure of the image photographing devices 44.

The image photographing devices 44 are installed in places along the display device 42 such that the landscape images around the display device 42, including the target person, can be captured at different angles, as shown in FIG. 3.

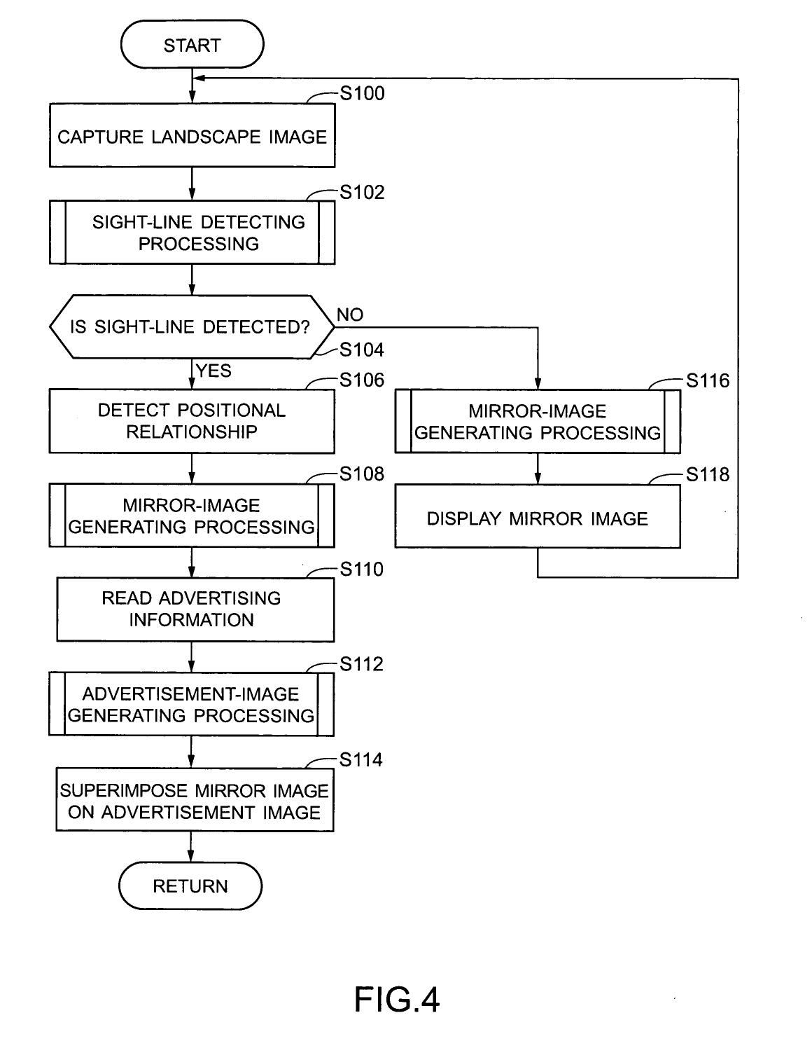

The CPU 30, which is a micro processing unit MPU or the like, invokes a predetermined program stored in the predetermined area in the ROM 32 to perform advertisement displaying processing shown in the flowchart in FIG. 4 in accordance with the invoked program.

FIG. 4 is a flowchart showing the advertisement displaying processing.

The advertisement displaying processing is a process for displaying a mirror image and an advertisement image of the target person in the display device 42. The process starts at Step S100 in the CPU 30, as shown in FIG. 4.

In Step S100, the process captures the landscape images around the display device 42, including the target person, with the image photographing devices 44 and proceeds to Step S102. In Step S102, the process performs sight-line detecting processing for detecting that one of target people around the display device 42 turns his/her line of sight upon the display device 42 based on the captured image and proceeds to Step S104.

In Step S104, the process determines whether one of the target people is detected turning his/her line of sight upon the display device 42 in the sight-line detecting process. If it is determined that one of the target people is detected turning his/her line of sight upon the display device 42 (Yes), the process proceeds to Step S106. In Step S106, the process detects the positional relationship between the target person who has turned his/her line of sight upon the display device 42 and the display device 42 based on the image captured in Step S100 and proceeds to Step S108. The positional relationship between the target person who has turned his/her line of sight upon the display device 42 and the display device 42 includes, for example, the relative position (angle and distance) of the target person with respect to the display device 42.

In Step S108, the process performs mirror-image generating processing for generating the mirror image of a peripheral landscape around the display device 42 based on the image captured in Step S100.

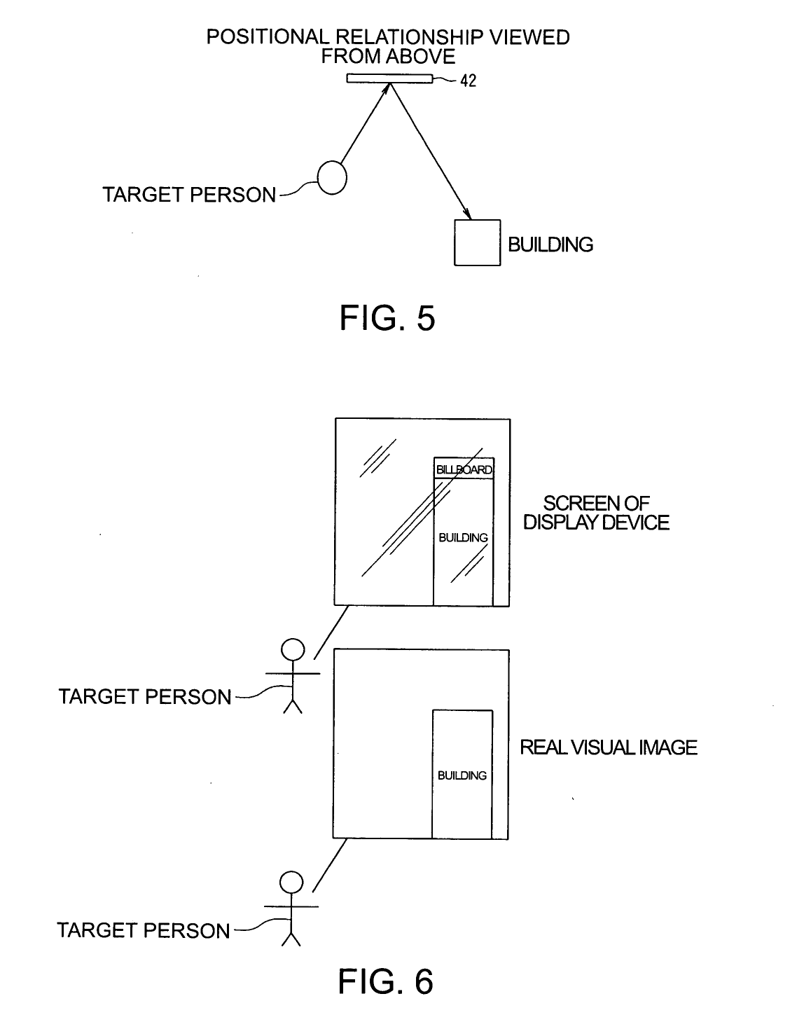

FIG. 5 illustrates a case in which a mirror image is generated.

In the mirror-image generating processing, when the display device 42 is a plane mirror that faces a predetermined direction (perpendicular to the display surface of the display device 42), the mirror image of the peripheral landscape that will be reflected in the plane mirror viewed from the target person is generated based on the image captured in Step S100 and the detected positional relationship, as shown in FIG. 5. Methods for generating a mirror image based on a plurality of images of a target person at different angles include a known method disclosed in, for example, Japanese Unexamined Patent Application Publication No. 2000-306092.

Referring to FIG. 4, in Step S110, the process reads the advertising information from the advertising-information registration DB 40 and proceeds to Step S112.

In Step S112, the process performs advertisement-image generating processing for generating an advertisement image such that the advertisement image becomes part of the peripheral landscape upon superimposition of the advertisement image on the generated mirror image, based on the read advertising information and the detected positional relationship.

FIG. 6 illustrates a case in which an advertisement image is generated.

In the advertisement-image generating processing, for example, when a building is reflected in a mirror image, an advertisement image of a billboard to be installed on the rooftop of the building is generated as if the billboard was installed on the rooftop of the building in the mirror image although the billboard is not actually installed on the rooftop of the building, as shown in FIG. 6.

Referring to FIG. 4, in Step S114, the process superimposes the mirror image generated in Step S108 onto the advertisement image generated in Step S112 to display the superimposed image in the display device 42. The process finishes a series of advertisement displaying processes and returns back to original processing.

In contrast, if it is determined in Step S104 that one of the target people is not detected turning his/her line of sight upon the display device 42 (No) in the sight-line detecting processing, the process proceeds to Step S116. In Step S116, the process performs the mirror-image generating processing for generating the mirror image of the peripheral landscape around the display device 42 based on the image captured in Step S100. In Step S118, the process displays the generated mirror image in the display device 42 and returns back to Step S100.

The operation according to the embodiments will now be described.

First, the mirror image of the peripheral landscape around the display device 42 is displayed in the display device 42 that is installed as part of the shop window. When one of target people who passes by on the road in front of the shop turns his/her line of sight upon the display device 42, the landscape images around the display device 42, including the target person, are captured with the image photographing devices 44 in Step S100. It is detected that one of the target people around the display device 42 turns his/her line of sight upon the display device 42 based on the captured images in Step S102.

After it is detected that one of the target people around the display device 42 turns his/her line of sight upon the display device 42, the positional relationship between the target person who turns his/her line of sight upon the display device 42 and the display device 42 is detected based on the captured images in Step S106. The mirror image of the peripheral landscape around the display device 42 is generated based on the captured images and the detected positional relationship in Step S108. Specifically, when the display device 42 is the plane mirror that faces a predetermined direction, the mirror image of the peripheral landscape that will be reflected in the plane mirror viewed from the target person is generated.

Next, the advertising information is read from the advertising-information registration DB 40 in Step S110, and the advertisement image is generated so as to become part of the peripheral landscape upon superimposition of the advertisement image on the generated mirror image based on the read advertising information and the detected positional relationship in Step S112.

The generated mirror image is superimposed on the advertisement image to be displayed in the display device 42 in Step S114.

As described above, according to the embodiments, the display device 42 for displaying the mirror image of the peripheral landscape that will be reflected in a mirror when a target person looks at the mirror and the advertising-information registration DB 40 for storing the advertising information are used. The advertisement image is superimposed on the mirror image displayed in the display device 42 to be displayed as part of the peripheral landscape based on the advertising information stored in the advertising-information registration DB 40.

Since the advertisement is presented with the display device 42, it is not necessary for the target person to wear an accessory such as a head-mounted display, thus an advertisement presentation system being less troublesome for the target person and having a relatively broad application is advantageously achieved, compared with conventional cases. Furthermore, since the advertisement image is displayed as part of the peripheral landscape, the advertisement is surprisingly presented to the target person as part of peripheral landscape in the mirror image of the display device 42 although the advertisement does not actually exist in a visual image. Hence, the target person is more impressed with the advertisement and advertising effect can be improved compared with conventional cases.

According to the embodiments, the plurality of image photographing devices 44 for capturing the landscape images around the display device 42 is used. The mirror image of the peripheral landscape around the display device 42 is generated based on the images captured with the image photographing devices 44, and the advertisement image is superimposed on the generated mirror image to be displayed in the display device 42 as part of the peripheral landscape based on the advertising information stored in the advertising-information registration DB 40.

Since the mirror image of the peripheral landscape around the display device 42 is generated based on the images captured with the image photographing devices 44, the mirror image that is close to an actual reflected image in the mirror can be generated. It is enough to superimpose the advertisement image on the mirror image generated in image processing, so that relatively easy and accurate superimposition of the advertisement image can be achieved.

According to the embodiments, the positional relationship between the display device 42 and the target person is detected. When the display device 42 is the plane mirror that faces a predetermined direction, the mirror image of the peripheral landscape that will be reflected in the plane mirror viewed from the target person is generated based on the detected positional relationship.

Since the mirror image of the peripheral landscape that will be reflected in the plane mirror viewed from the target person is generated, the mirror image that is closer to an actual reflected image in the mirror can be generated.

According to the embodiments, the positional relationship between the display device 42 and the target person is detected based on the images captured with the image photographing devices 44.

Since the positional relationship between the display device 42 and the target person is detected in the image processing, the positional relationship between the display device 42 and the target person can be relatively accurately detected.

According to the embodiments, it is detected that a person turns his/her line of sight upon the display device 42 based on the images captured with the image photographing devices 44. The person who turns his/her line of sight upon the display device 42 is the target person. When the display device 42 is the plane mirror that faces a predetermined direction, the mirror image of the peripheral landscape that will be reflected in the plane mirror viewed from the target person is generated.

When a plurality of persons exist around the display device 42, a person who turns his/her line of sight upon the display device 42 is the target person, and the mirror image of the peripheral landscape and the advertisement image that will be reflected in the plane mirror viewed from the target person are presented, thus achieving the advertisement presentation targeted at the person who turns his/her line of sight upon the display device 42. Hence, the target person is more impressed with the advertisement and the advertising effect can be further improved.

According to the above embodiments, the advertising-information registration DB 40 corresponds to presentation-information storing means in the first embodiment or the eighth embodiment or to advertising-information storing means in the second embodiment or the third embodiment. The display device 42 corresponds to a reflected-image displaying medium from the first to fifth embodiments and from the seventh to ninth embodiments or to displaying means in the third embodiment. The image photographing devices 44 and Step S100 correspond to landscape-image capturing means in the third embodiment, target-person-image capturing means in the fifth embodiment, or face-image capturing means in the seventh embodiment. Step S102 corresponds to sight-line detecting means in the seventh embodiment, Step S106 corresponds to positional-relationship detecting means in the fourth embodiment or the fifth embodiment, and Step S108 corresponds to mirror-image generating means in the third embodiment, the fourth embodiment, or the seventh embodiment. Step S114 corresponds to information displaying means in the first embodiment or the eighth embodiment, advertisement displaying means in the second embodiment or the third embodiment, a mirror-image displaying step in the ninth embodiment, or an information displaying step in the ninth embodiment.

According to the above embodiments, the advertising information corresponds to presentation information in the first embodiment, the eighth embodiment, or the ninth embodiment.

Although the above embodiments are structured such that the positional relationship between the display device 42 and the target person is detected based on the images captured with the image photographing devices 44, the present invention is not limited to this structure. A structure can be achieved in which the positional information of a communication terminal, such as a mobile phone or a personal digital assistant (PDA), that the target person carries is acquired vie communication with the communication terminal and the positional relationship between the display device 42 and the target person is detected based on the acquired positional information.

Since the positional relationship between the display device 42 and the target person is detected based on the positional information of the communication terminal that the target person carries, the positional relationship between the display device 42 and the target person can be relatively accurately detected. Furthermore, the positional relationship can be relatively easily detected, compared with cases in which the positional relationship is detected in the image processing.

In such a case, the display device 42 corresponds to a reflected-image displaying medium in the sixth embodiment.

Although the above embodiments are structured such that, when a building is reflected in a mirror image, an advertisement image of a billboard to be installed on the rooftop of the building is displayed in the display device 42 as if the billboard was installed on the rooftop of the building in the mirror image although the billboard is not actually installed on the rooftop of the building, the present invention is not limited to this structure. The following advertisement images can be displayed.

When the advertisement display apparatus 100 is installed in a shop that sells mobile phones, for example, if the target person looks at the display device 42, the mirror image of the peripheral landscape around the display device 42, including the target person, is displayed in the display device 42, and a commercial artist for the mobile phones appears behind the target person and looks back at the target person in the display screen of the display device 42.

The target person thinks that the commercial artist really appears behind him/her and looks back, but the commercial artist does not really exist there. When the target person looks at the display device 42 again, the commercial artist is reflected in the display device 42. At this time, the target person is aware that an advertisement is presented in the display device 42. In this manner, the target person is strongly impressed and therefore the advertisement can attract the attention of the target person. In such a case, the image of the commercial artist is an advertisement image.

Although the advertisement image that is displayed as a motion picture has not been specifically described in the above embodiments, the advertisement image can be displayed as a motion picture. For example, when the advertisement display apparatus 100 is installed in a shop that sells bags, a bag carried by the target person is replaced with a bag that is sold in the shop for display. In such a case, the image of the displayed bag is an advertisement image.

Although the above embodiments are structured such that the advertising information is read from the advertising-information registration DB 40 and the advertisement image is generated based on the read advertising information, the present invention is not limited to this structure. A network structure can be realized in which an advertising-information registering server having an advertising-information registration DB is connected to the advertisement display apparatus 100 for communication. Specifically, the advertisement display apparatus 100 transmits a request for acquiring the advertising information to the advertising-information registering server and generates the advertisement image upon reception of the advertising information based on the received advertising information. The advertising-information registering server reads the advertising information from the advertising-information registration DB upon reception of the request for acquiring the advertising information, and transmits the read advertising information to the advertisement display apparatus 100 that has transmitted the request.

Although the above embodiments are structured such that the advertising information is read from the advertising-information registration DB 40 and the advertisement image is generated based on the read advertising information, the present invention is not limited to this structure. A structure can be achieved in which target person information concerning the target person is acquired via communication with a communication terminal, such as a mobile phone or a PDA, that the target person carries, the advertising information is read from the advertising-information registration DB 40 based on the acquired target person information, and the advertisement image is generated based on the read advertising information. In such a case, the target person information is, for example, information concerning a hobby or taste of the target person or a contract with a certain company. When the information concerning a hobby or taste of the target person is adopted as the target person information, the advertisement involving the hobby or taste of the target person is displayed in the display device 42. When the information concerning a contract with a certain company is adopted as the target person information, the advertisement for commercial products or service that the certain company sells or provides or the advertisement for the certain company itself is displayed in the display device 42.

Although the above embodiments are structured such that the advertising information is read from the advertising-information registration DB 40 and the advertisement image is generated based on the read advertising information, the present invention is not limited to this structure. A structure can be achieved in which, when the target person looks at one of commercial products exhibited in a shop window, the advertising information concerning the commercial product is read from the advertising-information registration DB 40 and the advertisement image is generated based on the read advertising information.

Although the above embodiments are structured such that advertisement is presented regardless of the number of target people who pass by on a road in front of a shop, the present invention is not limited to this structure. A structure can be achieved in which the advertisement is presented in accordance with the number of target people who pass by on the road in front of the shop. For example, the advertisement is extensively presented when the road in front of the shop is bustling with people, and the advertisement is moderately presented during non-peak times.

Although the above embodiments are structured such that advertisement is presented regardless of the number of target people who pass by on a road in front of a shop, the present invention is not limited to this structure. A structure can be achieved in which the advertisement is presented in accordance with weather. For example, among commercial products A and B that are specialized in weather, the advertisement for the commercial product A is presented when it is raining and the advertisement for the commercial product B is presented when it is fine. In such a case, for example, the commercial product A is rain goods and the commercial product B is goods for a clear day.

Although the above embodiments are structured such that advertisement is presented regardless of the number of target people who pass by on a road in front of a shop, the present invention is not limited to this structure. A structure can be achieved in which, when the advertisement display apparatus 100 is installed in a quiet shopping street, a crowded street can be presented as the advertisement as if the street were crowded in the mirror image although the street is actually empty.

Although the above embodiments are structured such that, when the display device 42 is a plane mirror that faces a predetermined direction, the mirror image of the peripheral landscape that will be reflected in the plane mirror viewed from the target person is generated, the present invention is not limited to this structure. A structure can be achieved in which, when the display device 42 is a plane mirror that faces the front of the target person, the mirror image that will be reflected in the plane mirror viewed from the target person is generated.

Since the mirror image of the target person is always displayed in the display device 42 even when the target person slightly shifts, the advertisement display focused on the target person can be achieved. Hence, the target person is more impressed with the advertisement and the advertising effect can be further improved.

Although the above embodiments are structured such that the mirror image of the peripheral landscape around the display device 42 is generated based on the images captured with the image photographing devices 44 and the advertisement image is superimposed on the generated mirror image to be displayed in the display device 42 as part of the peripheral landscape based on the advertising information stored in the advertising-information registration DB 40, the present invention is not limited to this structure. A structure can be achieved in which, when a plane mirror is used for displaying the mirror image of the peripheral landscape around the display device 42, including the target person, the advertisement image is superimposed on the mirror image in the plane mirror to be displayed in the plane mirror as part of the peripheral landscape by projecting the generated advertisement image on the plane mirror with a projecting apparatus such as a projector.

Although the control program stored in advance in the ROM 32 is executed for performing the process shown in the flowchart in FIG. 4 in the above embodiments, the present invention is not limited to this structure. The program in a storage medium that stores the program describing the procedure may be read into the RAM 34 to be executed.

The storage medium here is a semiconductor storage medium such as a RAM or a ROM, a magnetic storage medium such as an FD (floppy disk) or an HD (hard drive), an optical storage medium such as a CD, a CDV, an LD, or a DVD, or a magnetooptic storage/optical storage medium such as an MO. Any storage medium can be used if it is a computer-readable storage medium, regardless of a reading system including an electronic reading system, a magnetic reading system, or an optical reading system.

Although the information presentation system, the advertisement presentation system, the information presentation program, and the information presentation method according to the present invention are applied to a case in which advertisement is presented to a target person with the display device 42 that is provided as part of a shop window, as shown in FIG. 2, in the above embodiments, the present invention is not limited to this structure. The information presentation system, the advertisement presentation system, the information presentation program, and the information presentation method according to the present invention can be applied to other cases without departing from the spirit and the scope of the present invention.

The entire disclosure of Japanese Patent Application No. 2002-363311 filed Dec. 16, 2002 is incorporated by reference.

What is claimed is:

1. An information presentation system comprising:
a reflected-image displaying medium for displaying a reflected image of a peripheral landscape that will be reflected in a mirror when a target person to whom information is presented looks at the mirror;
presentation-information storing means for storing presentation information to be presented; and
information displaying means for displaying the information in the reflected-image displaying medium based on the presentation information stored in the presentation-information storing means;
wherein the information displaying means superimposes the information on the reflected image displayed in the reflected-image displaying medium to display the superimposed information as part of the peripheral landscape, based on the presentation information stored in the presentation-information storing means.

2. An advertisement presentation system comprising:
a reflected-image displaying medium for displaying a reflected image of a peripheral landscape that will be reflected in a mirror when a target person to whom an advertisement is presented looks at the mirror;
advertising-information storing means for storing advertising information to be presented; and
advertisement displaying means for displaying the advertisement in the reflected-image displaying medium based on the advertising information stored in the advertising-information storing means,
wherein the advertisement displaying means superimposes an advertisement image on the reflected image displayed in the reflected-image displaying medium to display the superimposed advertisement image as part of the peripheral landscape, based on the advertising information stored in the advertising-information storing means.

3. The advertisement presentation system according to claim 2, wherein
the reflected-image displaying medium further comprises displaying means in which an image can be displayed,
the advertisement presentation system further comprises a plurality of landscape-image capturing means for capturing landscape images around the reflected-image displaying medium and mirror-image generating means for generating a mirror image of the peripheral landscape around the reflected-image displaying medium based on the landscape images captured with the landscape-image capturing means, and
wherein the advertisement displaying means superimposes the advertisement image on the mirror image that is generated in the mirror-image generating means to display the superimposed advertisement image in the displaying means as part of the peripheral landscape, based on the advertising information stored in the advertising-information storing means.

4. The advertisement presentation system according to claim 3, further comprising positional-relationship detecting means for detecting positional relationship between the reflected-image displaying medium and the target person,
wherein, when the reflected-image displaying medium is a plane mirror that faces a predetermined direction, the mirror-image generating means generates the mirror image of the peripheral landscape that will be reflected in the plane mirror viewed from the target person based on the result detected with the positional-relationship detecting means.

5. The advertisement presentation system according to claim 4, further comprising target-person-image capturing means for capturing an image of the target person,
wherein the positional-relationship detecting means detects the positional relationship between the reflected-image displaying medium and the target person based on the image captured with the target-person-image capturing means.

6. The advertisement presentation system according to claim 4, further comprising positional-information acquiring means for acquiring positional information of a communication terminal that the target person carries via communication with the communication terminal,
wherein the positional-relationship detecting means detects the positional relationship between the reflected-image displaying medium and the target person based on the positional information acquired with the positional-information acquiring means.

7. The advertisement presentation system according to claim 3, further comprising face-image capturing means for capturing a face image of a person around the reflected-image displaying medium and sight-line detecting means for detecting that the person turns his/her line of sight onto the reflected-image displaying medium based on the face image captured with face-image capturing means,
wherein the person who is detected turning his/her line of sight onto the reflected-image displaying medium with the sight-line detecting means is the target person and wherein, when the reflected-image displaying medium is the plane mirror that faces a predetermined direction, the mirror-image generating means generates the mirror image of the peripheral landscape that will be reflected in the plane mirror viewed from the target person.

8. An information presentation program that causes a computer to perform a process realized as information displaying means for displaying the information in the reflected-image displaying medium based on the presentation information stored in the presentation-information storing means, the computer being capable of utilizing a reflected-image displaying medium for displaying a reflected image of a peripheral landscape that will be reflected in a mirror when a target person to whom information is presented looks at the mirror and presentation-information storing means for storing presentation information to be presented,
wherein the information displaying means superimposes the information on the reflected image displayed in the reflected-image displaying medium to display the superimposed information as part of the peripheral landscape, based on the presentation information stored in the presentation-information storing means.

9. An information presentation method comprising:
a reflected-image displaying step for displaying a reflected image of a peripheral landscape that will be reflected in a mirror when a target person to whom information is presented looks at the mirror in reflected-image displaying medium; and
an information displaying step for displaying the information in the reflected-image displaying medium based on presentation information to be presented, wherein the information is superimposed on the reflected image displayed in the reflected-image displaying medium to display the superimposed information as part of the peripheral landscape based on the presentation information in the information displaying step.

10. An information presentation system comprising:
a reflected-image displaying medium displaying a reflected image of a peripheral landscape that is reflected in a mirror when a target person to whom information is presented looks at the mirror;
a presentation-information database storing presentation information to be presented; and
an information display displaying the information in the reflected-image displaying medium based on the presentation information stored in the presentation-information database;
wherein the information display superimposes the information on the reflected image displayed in the reflected-image displaying medium to display the superimposed information as part of the peripheral landscape based on the presentation information stored in the presentation-information database.
